(19) United States
(12) Patent Application Publication
(10) Pub. No.: US 2023/0334587 A1
(43) Pub. Date: Oct. 19, 2023

(54) Artificial Intelligence Coach

(71) Applicant: Tractable Ltd, London (GB)

(72) Inventors: Crystal Kelly VAN OOSTEROM, London (GB); Bernardo MARQUES, London (GB)

(21) Appl. No.: 18/303,053

(22) Filed: Apr. 19, 2023

Related U.S. Application Data
(60) Provisional application No. 63/363,196, filed on Apr. 19, 2022.

(51) Int. Cl. G06Q 40/08; G06Q 10/0639

(52) U.S. Cl. CPC G06Q 40/08; G06Q 10/06398

(57) ABSTRACT

An artificial intelligence (AI) system is configured to receive first historical data for an entity related to an insurance claims operation, the first historical data including performance-related parameters and at least one associated performance metric for claims processed by the entity during a first duration of time, wherein the first historical data is parameterized for input into one or more artificial intelligence (AI) models, identify, from the AI model fit to the first historical data, one or more of the performance-related parameters that influenced the at least one associated performance metric, determine, from one or more performance-related parameters, a recommendation to improve the at least one associated performance metric and provide a notification of the recommendation.

### PRIORITY/INCORPORATION BY REFERENCE

This application claims priority to U.S. Provisional Application 63/363,196 filed on Apr. 19, 2022 and entitled “AI Coach,” the entirety of which is incorporated herein by reference.

### BACKGROUND

Insurance companies operate within a complex space in which the drivers of performance are not readily apparent. A key metric used to characterize the performance of an insurer is the combined ratio, which is defined as

$$Combined ratio = \frac{Paid claims + expenses}{Earned premiums} .$$

A combined ratio less than 100% is indicative of net positive profitability, while a combined ratio greater than 100% is indicative of net negative profitability. A primary aim of insurers is to achieve a strong (low) combined ratio. However, the industry trend in recent years is an increase in combined ratio, particularly in property and casualty (P&C) insurance. There is large variance across countries and companies, and relatively small margin for error in terms of achieving profitability. Particularly with regard to expenses, one metric for administrative costs per policy increased by 34% in the US over the last ten years.

It is a challenge for most insurers to find the right balance at scale between operational costs, customer experience and ensuring consistency in repairs while also achieving profitability.

### SUMMARY

Some exemplary embodiments are related to a method for receiving first historical data for an entity related to an insurance claims operation, the first historical data including performance-related parameters and at least one associated performance metric for claims processed by the entity during a first duration of time, wherein the first historical data is parameterized for input into one or more artificial intelligence (AI) models, identifying, from the AI model fit to the first historical data, one or more of the performance-related parameters that influenced the at least one associated performance metric, determining, from one or more performance-related parameters, a recommendation to improve the at least one associated performance metric and providing a notification of the recommendation.

Other exemplary embodiments are related to a system having a memory configured to store first historical data for an entity related to an insurance claims operation, the first historical data including performance-related parameters and at least one associated performance metric for claims processed by the entity during a first duration of time, wherein the first historical data is parameterized for input into one or more artificial intelligence (AI) models. The system also includes one or more processors configured to identify, from the AI model fit to the first historical data, one or more of the performance-related parameters that influenced the at least one associated performance metric, determine, from one or more performance-related parameters, a recommendation to improve the at least one associated performance metric and provide a notification of the recommendation.

### BRIEF DESCRIPTION OF THE DRAWINGS

FIG. 1 shows a first view of a first dashboard which provides a holistic tool to manage performance metrics within an ecosystem of configurable organizational levers comprising additional modules according to various exemplary embodiments described herein.

FIG. 2 shows a second view of a first dashboard which provides a holistic tool to manage performance metrics within an ecosystem of configurable organizational levers comprising additional modules according to various exemplary embodiments described herein.

FIG. 3 shows a first view of a second dashboard which provides an expert behavior tool offering real-time performance insights and coaching according to various exemplary embodiments described herein.

FIG. 4 shows a second view of a second dashboard which provides an expert behavior tool offering real-time performance insights and coaching according to various exemplary embodiments described herein.

FIG. 5 shows a first view of a third dashboard which provides a bodyshop behavior tool offering real-time bodyshop performance insights and network monitoring according to various exemplary embodiments described herein.

FIG. 6 shows a second view of a third dashboard which provides a bodyshop behavior tool offering real-time bodyshop performance insights and network monitoring according to various exemplary embodiments described herein.

FIG. 7 shows a view of a fourth dashboard which provides a back-end triage tool identifying the low-saving claims that do not require expert intervention according to various exemplary embodiments described herein.

FIG. 8 shows a method for an AI-based performance assessment according to various exemplary embodiments described herein.

FIG. 9 shows an exemplary system for implanting the AI system according to various exemplary embodiments described herein.

### DETAILED DESCRIPTION

According to various exemplary embodiments described herein, an artificial intelligence (AI) system is provided to identify the main drivers behind the values of various performance metrics related to the insurance claims process. The AI system identifies key metrics or influences in the complex data and provides insights to improve the performance of the insurer at various organizational levels, including, e.g., the repair shop level, the claims adjuster level, an automated claims review system level, etc. In one aspect, a flagging and notification system is provided to flag insights determined by the AI system and notify individuals or entities in the insurance claims process when these insights can be used to improve the performance of the individual/entity. In another aspect, a tracking system is provided to track the performance of these various individuals/entities across the insurance claims process when the system has a particular interest in the individual/entity, for example, an interest in determining whether a particular remedial measure suggested to or applied to the entity was effective in improving performance. In still another aspect, a simulation system can simulate the effect that changes in rules or policies could have on the performance metrics. The AI system can continuously re-assess how various rule changes or policy changes have actually impacted performance metrics and compare these actual results to previously simulated results to refine and improve future simulations.

The AI system can provide a real-time view of team metrics vs. peers. This can be done at the team level and the individual team member level. Alerts can be generated for performance issues that require action. The AI system can provide AI-based recommendations to improve key metrics. Additional AI-based recommendations can be provided to the team lead (supervisor). Coaching opportunities can be found by the AI system that are expert-specific. Additionally, examples of issues/errors can be generated for coaching/discussion. The various AI features that could be included in the AI system are described in detail below.

The AI system can have specific modules tailored to specific metrics or insight generation applications. The following disclosure refers to various individuals or entities of or related to an insurance company, those entities including: the “claims department” that processes customer claims for insurance coverage; the “claims director,” who works for the insurance company and runs the claims department; the “expert supervisor,” who works for the insurance company and manages a group of professional claims adjusters; the “claims adjuster” or “expert” who analyzes claims for insurance coverage and, if necessary, performs an on-site inspection of the vehicle; the “repair shop manager,” who supervises the repair shops used by and/or partnered with the insurance company; the “repair shop” or “bodyshop” that works with the insurance company and performs vehicle inspections and/or repairs for damaged vehicles; the “automated claims processing system” that is utilized by the insurance company to process certain claims automatically when a human claims adjuster is not needed. Specific modules of the AI system can be directed to different aspects of the insurance claim process. For example, performance metrics can be assessed and insights determined for a particular individual (e.g., claims adjuster, mechanic, supervisor, team leader, etc.); a particular group of individuals (e.g., a team of claims adjusters or a group of managers) or a particular service (e.g., a repair shop, an automated claims processing system, etc.).

In the following, three scenarios of the claim resolution process are referred to in various examples describing the functionality of the AI system, specifically: 1) the oversight of a team of claims adjusters by an expert supervisor working for the insurance company; 2) the oversight of a group of repair shops by a repair shop manager working for the insurance company; and 3) the oversight of an automated claims processing system by one or more individuals working for the insurance company. These three scenarios will be used to illustrate the functionality of the AI system in practice. In some embodiments, determined information (e.g., performance metrics and insights) can be provided via the AI system to an individual having supervisory capacity over some individuals/entities, who can interact with the AI system to execute additional steps in dependence on the information, while in other embodiments this determined information (or part thereof) can be provided directly to the individuals/entities so that the processes and/or rules by which the individual/entity operates can be adjusted in dependence on the information.

Those skilled in the art will understand that the principles described herein can be applied to many different scenarios and organizational levels that will vary based on the organizational structure of the particular insurance company executing the AI system. Those skilled in the art will also understand that the various processes described herein can be configurable for many different types of analyses, as will be described in greater detail below.

Those skilled in the art will understand that the “automated claims processing system” refers to an automated service within the insurance company that can process certain claim decisions automatically when a human claims adjuster or other human actor is not needed. The automated system can be designed so that claims having certain qualities, e.g., low cost, can be handled according to predefined system rules. The automated system can include various thresholds, e.g., cost or labor hours thresholds, that can be used to determine whether the claim should be automatically reviewed or reviewed by a human claims adjuster. In another example, the thresholds could be based on a certainty of one repair operation versus one identified by a human operator (such as during a review or an audit of a bodyshop estimate by an insurance company). Additionally, certain bodyshops can be eligible for automatic review of claims while other bodyshops are not eligible for automatic review. In some scenarios, a claim that was initially reviewed by the automated system could be passed to a human claims adjuster, e.g., if unforeseen complications are encountered during the repair process.

In one aspect of these exemplary embodiments, detailed statistics/metrics are generated from historical data concerning the oversight of the various individuals/entities involved in the claims resolution process. Performance-related parameters can vary across different individuals/entities and depend on the nature of the work performed by that individual/entity. Similarly, performance metrics determined based on these performance-related parameters can vary across different individuals/entities. For example, the primary performance metric for the insurance company (for, e.g., the insurance company considered as a whole, for departments within the insurance company, for divisions within the same department, for individuals working within each division, etc.) can be the combined ratio, as discussed above, while the primary performance metric for a repair shop or for other entities involved in the claims resolution process could be a different metric. Other performance metrics that can be used by the AI system include, but are not limited to: customer experience-related metrics; repair quality; expense; speed of repair; incorrect first notice of loss decisions; rate of compliance/adoption of regulatory, insurer or industry standards, etc.

Various parameters can impact the calculated value of the performance metric, directly or indirectly. For example, expense-related parameters directly impact the combined ratio (e.g., when relatively high expenses directly increase the calculated combined ratio). In another example, improper repair operations can indirectly impact the calculated combined ratio (e.g., when improper repair operations cause additional expenses that could have been avoided). In yet another example, an incorrect decision to repair a car that later is determined by a bodyshop to be totaled can result not only in increased time until the customer's claim is resolved, but added costs to the insurer from the bodyshop with respect to vehicle storage.

In the exemplary first scenario described above (e.g., team leader of claims adjusters), an expert module of the AI system receives historical data relating to the performance of each one of a team of claim adjusters or experts. The historical data for a particular one of the claims adjusters can include, for claims previously assigned to and resolved by the claims adjuster: identifying information characterizing the claim (vehicle type, damage type, etc.); man-hours needed to resolve the claim; absolute time required to resolve a claim; total payout from the claim; customer satisfaction; number of supplements prior to final estimate; circumstances of accident; and other types of historical data, as well as images of the damaged vehicle.

In the second exemplary scenario described above, e.g., a bodyshop module of the AI system receives historical data relating to the performance of each one of a group of repair shops. The historical data for a particular repair shop can include, for repair jobs assigned to and performed by the repair shop: identifying information characterizing the repair work (make/model/year of the vehicle, damage fixed, supplemental damage identified during the repair process, etc.); labor and parts cost; man hours; paint used; paint cost; paint blending; time from receiving the vehicle to returning the vehicle; use of green or recycled parts; repair/replace ratios; customer satisfaction; images of the damaged vehicle; and other types of historical data.

In the third exemplary scenario described above, a simulation module of the AI system receives historical data relating to the performance of an automated claims processing system for resolving claims without expert review. The historical data for the automated claims system can include, for each claim automatically resolved without expert review: identifying information characterizing the claim (vehicle type, damage type, etc.); total payout from the claim; customer satisfaction; images of the damaged vehicle; and other types of historical data. In one example, a claim that was automatically approved by the automated claims processing system at an early stage of the claim process could have resulted in additional administrative costs further along in the repair process, for example, if supplemental damage is discovered during inspection by the repair shop. Data parameters contextualizing these types of scenarios can also be generated. This historical data can further be associated with the parameters of the automated system that were in use at the time the claim was automatically resolved, including, e.g., cost/savings thresholds and/or other thresholds that directed the claim resolution to the automated system.

This historical data can be updated in substantially real-time as claims are processed and/or completed by the claims adjuster or the automated claims processing system or as repairs are processed and/or completed by the repair shop.

From this historical data, performance metrics can be generated that characterize the performance of these individuals/entities. For example, as discussed above, the combined ratio is considered a valuable metric for gauging profitability. Thus, the parameters included in the historical data can be associated with performance metrics.

In another aspect of these exemplary embodiments, the AI system identifies trends in the data by fitting one or more AI models to the detailed input data discussed above, including both the historical data and the metrics characterizing the performance of these individuals/entities. The data can be parameterized and input to the AI system to determine how various parameters drive the performance metrics by finding associations between particular parameters and the resulting performance. For example, certain parameters and their associated values can have a high correlation with positive performance metrics while other parameters can have a high correlation with negative performance metrics. In some aspects, the AI system can analyze data from multiple individuals/entities in combination while in other aspects, the AI system can analyze the data of a particular individual/entity in isolation.

In the first exemplary scenario discussed above, the expert module can determine that a particular parameter type or parameter value from the historical data of the claims adjuster team is a primary driver of high performance for adjusters while another parameter or parameter value is a primary driver of low performance for adjusters. For example, the expert module can determine that high performance adjusters resolve claims within an average of X hours, while low performance adjusters frequently perform or order on-site inspections of claims.

In the second exemplary scenario discussed above, the bodyshop module can determine that a particular parameter type or parameter value from the historical data of the repair shops is a primary driver of high performance for repair shops while another parameter or parameter value is a primary driver of low performance for repair shops. For example, the bodyshop module can determine that high performance repair shops complete certain types of repairs (as opposed to part replacements) within an average of X hours, while low performance adjusters rarely identify supplementary damage at an early stage of repairs.

In the third exemplary scenario discussed above, the simulation module can determine that a particular parameter type or parameter value from the historical data of the automated claims processing system is a primary driver of high performance for the automated claims processing system while another parameter or parameter value is a primary driver of low performance for the automated claims processing system. For example, the simulation module can determine that high performance is achieved when certain cost/savings thresholds are used and that low performance results when certain other cost/savings thresholds are used.

The determination of trends in the historical data, described above, can comprise a brute force approach, e.g., a brute force grid search, to determine correlations between the parameterized input data (historical data) and the resulting performance metrics. The AI system can identify various parameters that have a direct and/or outsize influence on the performance metrics. However, the data set can become more enriched over time, and more advanced AI techniques can be used to determine the trends and for additional functionality to be described below.

For example, in some scenarios, the trends identified by the system can be relatively straightforward and determinable from a simple analytics tool. For example, a claims adjuster or repair shop that typically takes a longer time to complete claims/repairs could be associated with poor performance metrics, and the AI system could find that this time parameter was the most important driver of the poor performance metrics. In other scenarios, however, more complicated insights can be gleaned. A dataset that is enriched with substantial amounts of metadata can be parameterized and hidden correlations can be found using a properly fit model, to be described in greater detail below.

In another aspect of these exemplary embodiments, the AI system includes one or more inference modules for generating insights to improve performance based on the trends identified in the data. These insights could lead to operational adjustments for one or more aspects of the AI system or for the individuals/entities.

For example, in some scenarios, an individual may be identified as having poor performance due to excessive use of time in performing tasks, e.g., resolving claims, performing repairs, etc. In these scenarios, a relatively simple insight can be determined—that this individual should spend less time in performing these tasks or that additional resources should be provided to this individual. However, other types of insights can also be determined. For example, in another scenario, the individual may be identified as having poor performance due to too little time being spent performing tasks. A simple insight can be determined—that this individual should spend more time in performing these tasks. Deeper insights can also be determined—that the workload of this individual is too cumbersome and that the individual rushes through tasks in an effort to not fall behind on work.

In still another example, the automated claims processing system may be identified as having poor performance due to the values of the cost/time thresholds (used to determine whether the claim is automatically resolved or assigned to a human claims adjuster) being too high or too low. In these scenarios, the AI system could determine the insight that one or more of the thresholds should be adjusted. In another example, certain repair shops used in the automatic processing of claims could be identified as having poor performance. In this scenario, the AI system could determine the insight that this repair shop should not be eligible for automatic claims processing.

In some scenarios, the AI system could determine the insight that the primary driver of the poor performance of an individual/entity is substantially unrelated to the actions taken by that individual/entity. For example, the relatively high cost incurred could be the result of external forces, e.g., inflation, supply chain issues, etc.

Some of these insights may require manual interpretation by an operator of the AI system. For example, the AI system can present an insight to an individual, e.g., the team leader of the claims adjusters with access to a particular module of the AI system, and this individual can assess whether he/she is in agreement with the AI system. If the individual agrees with the AI-generated insight, then the insight can be validated. If the individual does not agree with the AI-generated insight, then the insight can be dismissed. These decisions can be logged by the AI system to improve the generation of inferences in future cases.

Additionally, in evaluating these scenarios, the complexity or other characteristics of the claims (such as the ratio of luxury to budget vehicles, cars less than one year old to cars older than one year, or import vs domestic vehicles) can be evaluated to determine if the reason for the difference in the metrics is due to factors outside the control of the individual, or entity. Additionally, this complexity measurement can be used to adjust the scores of the measured entity to take into account the differences in types of claims.

In still another aspect of these exemplary embodiments, the AI system can include one or more simulation modules for simulating the effect that adjusted performance-related parameters could have on the performance metrics. As described above, the AI system gathers extensive input data for some individual/entity and models the data to finds correlations therewithin. To simulate the performance of the individual/entity under some different circumstances, the AI system can adjust the parameters and generate simulated performance metrics that result from the adjusted parameters. The simulation module can be used to analyze any individual/entity in claims resolution process, but may have specific applicability to the automated claims processing system. For example, simulations can be generated using different thresholds or other parameters to estimate the performance of the automated system operating under different rules.

The simulation module(s) can be continuously refined and improved based on a comparison of simulated results (prior to implementation of new rules/policies/guidelines) and actual results (after the implementation of new rules/policies/guidelines). The data gathered by the AI system can be enriched in a variety of ways, to be explained in detail below. In some exemplary embodiments the simulations may be run in real time as the AI gathers more data. For example, the AI may be programmed to run simulations based on a threshold of new collected data, based on the passage of a predetermined amount of time, etc. In other exemplary embodiments, different simulations may be automatically triggered based on the collection of new data, e.g., simulations using different thresholds, simulations based on different rules, etc. By continually refining and improving the simulation modules the system avoids the impact of other players in the ecosystem “playing the system” to avoid for example triggering a human review of a claim by staying just below a perceived threshold. By frequently recalculating the simulated results, the most current situation in the relevant ecosystem can be evaluated.

In another aspect of these exemplary embodiments, the AI system includes an automatic (or semi-automatic) flagging and notification system for identifying individuals/entities that should be monitored more closely and informing these (and other) entities of insights that can improve their performance. The AI system can, for example, identify poor performance and implement remedial measures by determining an insight to improve the performance and providing this insight to an interested person/group of people. In some cases, strong performance can be identified for an individual/entity and insights determined regarding why the performance was strong. If this insight could have applicability to individuals/entities other than the strong-performing individual/entity, then the insight can be shared more broadly. Instead of providing a flag, the system could automatically adopt measures such as changing of various threshold values in an automatic claims processing system.

As described above, the performance of an individual/entity can be determined in a variety of ways. For example, certain performance thresholds can be set for an individual or entity (claims adjustor, repair shop) and, when the performance of the individual fails to meet the threshold levels aggregated over some predetermined span of time, the AI system can determine that the performance of the individual/entity can be improved.

When the AI system determines that the performance of the individual/entity is noteworthy or significant, then the AI system can flag this individual/entity. Each entity identified by the system, e.g., an individual; a division; a repair technician, a repair shop, can have a profile associated therewith and performance metrics further associated therewith. In some embodiments, an entity can be flagged and a review period can be introduced for the entity. The flagging of the individual/entity can be automatic, e.g., the individual/entity is associated in the system with the flag. Alternatively, the AI system can provide suggestions that an individual/entity be flagged, subject to review by an employee of the insurance company.

Different flags can be used for different reasons. A flag for poor performance could, for example, trigger other processes such as: notifying the poor performer; notifying other employees of the insurance company (e.g., managers); determining one or more insights for improving performance; implementing remedial measures or new policies in other facets of the insurance company; or implementing a probationary period for the poor performer, to be explained in further detail below. A flag for strong performance could trigger different processes, e.g., the strong performer may not be notified, the insight characterizing the strong performance could be shared with other entities (e.g., for informational purposes), etc. Those skilled in the art will ascertain that other types of flags could also be used depending on the preferences of the insurance company.

In one aspect, when an individual/entity is flagged for poor performance, the AI system can determine suggestions for remedial measures. For example, the AI system can determine that a claims adjuster is spending an excessive amount of money in performing on-site inspections. The AI system can further determine an insight related thereto, e.g., that the claims adjuster should perform fewer on-site inspections. In some scenarios, more than one insight can be determined to improve performance. This insight can be determined based in part on the results of simulations, as described above.

When the individual/entity has been flagged and remedial measures have been optionally determined, the AI system can notify the individual of the flagging and optionally provide the remedial measures to the individual/entity. The flag can indicate to the individual that their performance is lacking, and the remedial measures can suggest ways for the individual/entity to improve their performance.

In some aspects, the notification system can provide insights to individuals/entities based on the data or performance metrics of other individuals/entities. For example, an analysis of one team of claims adjusters can yield an insight that may have applicability to other teams of claims adjuster in the insurance company. In these scenarios, an insight that is determined to be useful to other individuals/entities can be provided to these individuals/entities by the notification system of the AI system.

In still another aspect, the AI system includes a tracking system for tracking the performance of an individual/entity over some duration of time, especially if, e.g., the individual/entity has been flagged for poor performance and provided with suggestions to improve their performance. In some scenarios, a probationary period can be determined, during which the performance of the individual/entity is analyzed with greater scrutiny than other individuals/entities that were not flagged by the AI system. The tracking system can generate data (performance-related parameters) for the entity during this probationary period and track changes in the performance metrics of the entity.

This individual/entity tracking data can be used directly when assessing whether the performance of the individual/entity has improved. The performance of the individual/entity prior to the probationary period can be compared to the performance during the probationary period, and other metrics can be generated to characterize the change in performance (if any). After the probationary period, the AI system can determine whether further remedial measures are warranted based on this analysis. The AI system could determine whether the flag on the individual/entity should be maintained, adjusted, or removed. For example, further remedial measures could be determined if the poor performance is maintained, while no remedial measures may be necessary if the poor performance was improved.

In another aspect, this individual/entity tracking data can also be used in further AI processes assessing the effect produced by the recommendation. The perceived effect of an insight or probationary period on the entity/entities under review, as determined during or after the review is complete, can also be parameterized and input to the AI system to assess the effectiveness of various insights on improving performance. For example, over time, a particular insight can be provided to multiple people. With a sufficiently large sample size, the AI system can determine whether the insight could be correlated to improved performance.

In one example, consider a scenario where the AI system identified excessive cost as the primary driver of an claim adjuster's poor performance metrics and where the AI system flagged the employee and provided the employee with a warning and a suggestion (or multiple suggestions) for ways to improve performance, e.g., reduced on-site inspections. After the probationary tracking period is complete, the AI system can determine the likelihood that the suggestion(s) directly influenced the subsequent performance metrics for the probationary period. In one example, the AI system could determine that the on-site inspections were reduced but the performance did not improve, implying that on-site inspections were not the issue and some other factor contributed to the poor performance. The AI system could use this knowledge when determining further insights to provide to further individuals/entities. In another example, the AI system could determine that the on-site inspections were not reduced but the performance did improve, implying that on-site inspections were not the issue. The claims adjuster could have been spurred to improve their performance based solely on the flag (and the knowledge that the performance should improve). The AI system could analyze what other performance parameters changed during the probationary period, and use this knowledge when determining further insights to provide to further individuals/entities.

To provide an illustrative example, the AI system could inform a repair shop that the primary factor influencing the repair shop's net negative profitability is excessive cost when performing simple repairs, even though the repair shop performs well when performing complex repairs. This excessive cost for simple repairs could be attributed to any of a variety of factors, e.g., specific employees handling specific repairs, the mechanical capabilities of the repair shop, etc. The repair shop could enter a probationary period during which remedial measures should be taken. At the end of the probationary period, it is determined how the performance metrics during the probationary period compare to the performance metrics from before the probationary period. If the performance metrics improve, then the system can determine why the performance metrics improved. For example, the repair shop could have improved its processes for conducting simple repairs. In another example, the performance for simple repairs could have remained poor, while other processes within the repair shop improved. Thus, the effectiveness of the recommendation can be tracked to determine the efficacy of the insights.

In addition, different metrics/data can be tracked over time, including: hiring/firing information for individuals and comparative performance analyses across individuals.

In still another aspect, the AI system can compare the different ways that claims are handled. For example, historical data can be generated and respective performance metrics can be determined for: claims handled by the automated claim handling system; claims handled by a claims adjuster; claims initially handled by the automated claim handling system but subsequently requiring attention from a claims adjuster, e.g., when supplemental damages are discovered during the repair process; claims requiring the claims adjuster to send an expert into the field to perform an on-site inspection; etc. Various categories of claims can be established, and the performance metrics for the claim resolution can be compared to identify trends and insights. For example, the AI system may determine that the thresholds for the automated system should change so that fewer claims are resolved automatically. This determination could be based on an analysis of claims adjusters in combination with the automated system.

As the complexity and granularity of the data increases, more advanced machine learning (ML) or AI schemes can be introduced to the AI system. For example, the AI system can comprise a deep learning neural network, etc. Any type of mathematical modeling (statistical or otherwise) could be used. For example, a non-linear hierarchical algorithm, a neural network, a convolutional neural network, a recurrent neural network, a long short-term memory network, a multi-dimensional convolutional network, a memory network, a fully convolutional network, a transformer network or a gated recurrent network.

The functionality described herein can be executed at a server or across multiple servers. In one embodiment, certain aspects of the AI system can be run continuously or semi-continuously (e.g., only during working hours) so that insights can be determined on a continuous basis. By continuously running various processes or sub-processes, the AI system can generate a large amount of information characterizing the claims process over time.

The functionality described herein can be implemented via a series of modules operating in coordination to assess performance and provide remedial measures to improve performance. These modules will be described with reference to the below described figures that illustrate various views that may be generated by the modules.

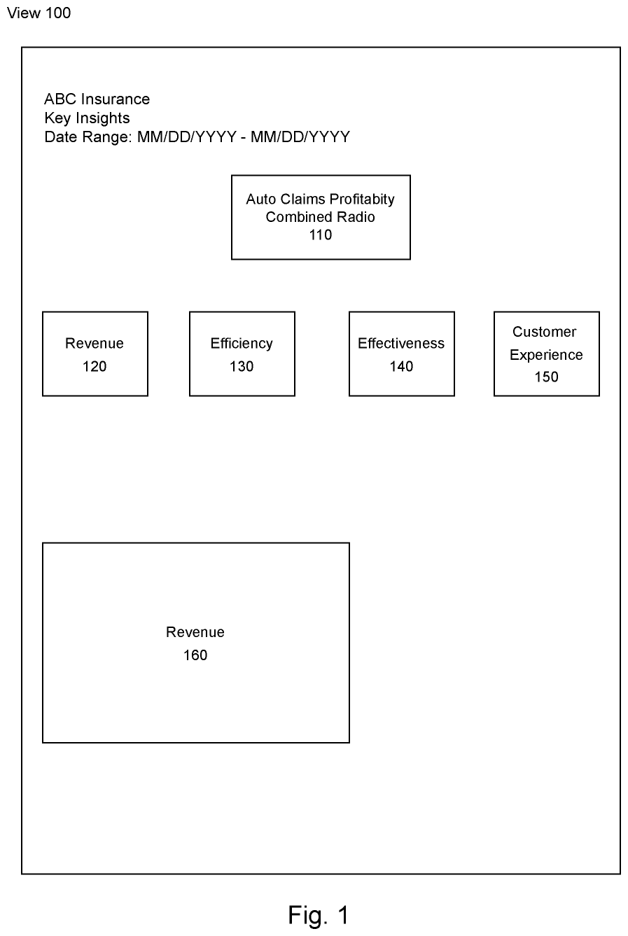

FIG. 1 shows a first key insights view 100 of a first dashboard which provides a holistic tool to manage performance metrics within an ecosystem of configurable organizational levers comprising additional modules. As shown in FIG. 1, this first view 100 may show key insights for the claims process. The module generating the views 100 and 200 (described below) may be a supervisor module for the entire claims process and can receive information from each of the other modules to provide aggregated metrics and insights on a high level, e.g., a claims director level. As will be described in more detail below, the other modules can be accessed via the AI Optimizer. Key metrics can be provided on the organizational level, for example, the combined ratio 110; revenue 120 (e.g., total earned premiums); efficiency 130 (e.g., expert expenses); effectiveness 140 (e.g., total claim payout); customer experience 150 (e.g., average key to key time); and other metrics. These metrics can be provided for the insurance company as a whole; for divisions within the insurance company; or at another layer within the company. These metrics can be generated for any time span, e.g., a particular month; multiple months; a year; etc. Graphical plots can be generated showing the performance of the company relative to various benchmarks, e.g., as shown by the larger revenue box 160. Thus, the AI Optimizer can provide high level metrics that can be used to influence high level decisions and provides a GUI for accessing the other modules. It should be understood that the above described key metrics are only exemplary and other metrics may be used to show various aspects of performance on a high level. In addition, as will be described in greater detail below, more specific metrics may be displayed in a similar manner by different modules to identify key insights for specific operations or subprocesses of the claims process, e.g., expert review, body shop performance, etc.

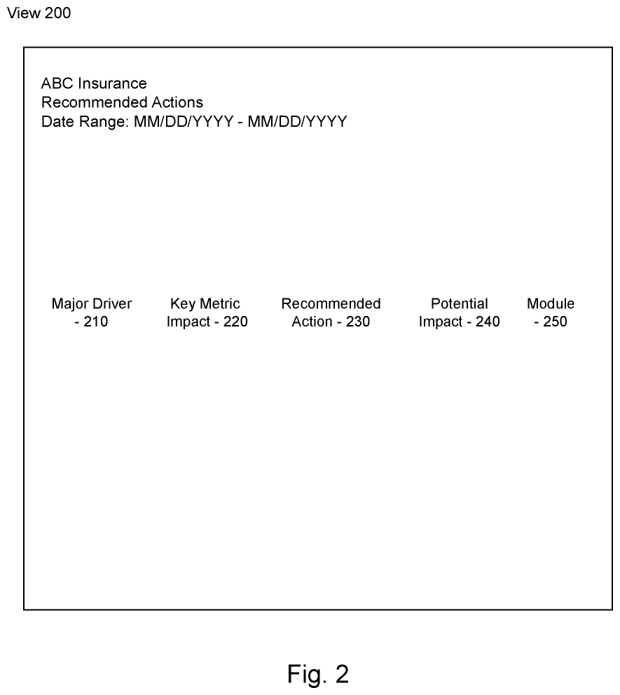

FIG. 2 shows a second view 200 of a first dashboard which provides a holistic tool to manage performance metrics within an ecosystem of configurable organizational levers comprising additional modules. As shown in FIG. 2, this second view 200 may show recommendations to improve the claims process with respect to the key metrics shown in FIG. 1. Thus, view 200 may show a major driver 210 of a negative metric. Some examples of these major drivers were provided above, but some additional examples are also provided. For example, a major driver of a poor metric may be based on the allocation of time for experts such as experts spending too much time on low value claims. Another example of a major driver may be paint standards of a particular bodyshop. It should be understood that many other examples of major drivers may exist and the AI may identify these major drivers based on the claims data that is entered into the AI. The view 200 may also identify the key metric impact 220 that may be improved by addressing the corresponding major driver. The view 200 may also include one or more recommendations 230 for addressing the major driver to improve the key metric. Again, examples of recommendations were provided above and some additional examples will be provided below. The view 200 may also show the potential impact on the key metric if the recommendation is implemented, e.g., a potential percentage change of the key metric. Finally, the view 200 may identify the tool 250 (e.g., another module) that generated the key metric/recommendation information and also allows a user to access this other module to view more detailed information regarding the subprocess affecting the claims process.

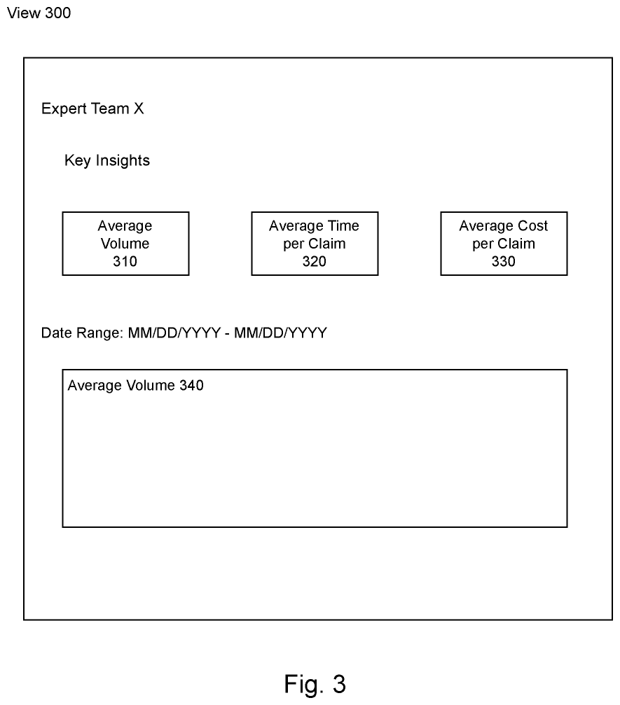

FIG. 3 shows a first view 300 of a second dashboard which provides an expert behavior tool offering real-time performance insights and coaching. The view 300 may be generated by an expert module and include key insights (e.g., key metrics) into the performance of a team of experts (e.g., Expert Team X as shown in the example of FIG. 3) or individual experts. The individual who may be viewing the view 300 may be for example, a supervisor of the Expert Team X. The claims process may be split into various constituent parts and one of the constituent parts may be an expert review of the claim. The expert module may include a model that analyzes all the claims that have been reviewed by experts and generates the key metrics that are illustrated in view 300, e.g., the average volume 310 of claims performed by the expert, the average time 320 per claim and the average cost 330 per claim. These metrics may include a ranking of the expert in the category against other experts that are part of a team, part of a region, etc. (e.g., in average volume 310 of claims performed by the expert, the expert X ranks 3^{rd} of 20 experts). The key metrics may be displayed for any appropriate date range and may also be expanded and be shown in graphical form as indicated by the example of the larger box 340 for the average volume key metric.

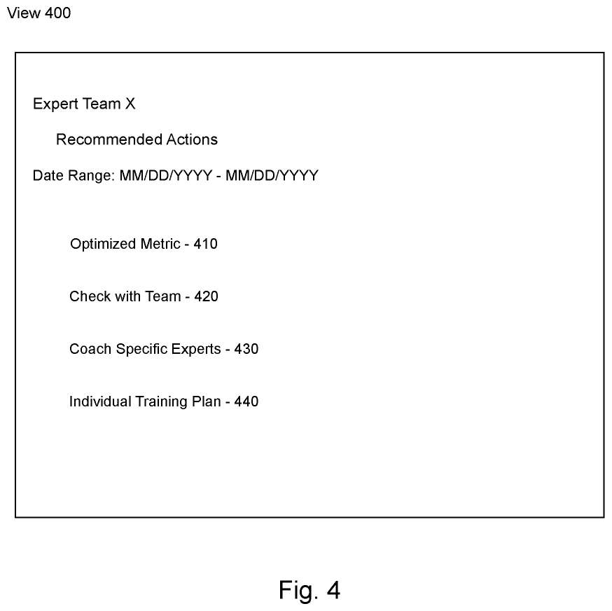

FIG. 4 shows a second view 400 of a second dashboard which provides an expert behavior tool offering real-time performance insights and coaching. The view 400 may also be generated by the expert module that generated the view 300. As shown in FIG. 4, this second view 400 may show recommendations to improve the claims process with respect to the expert team. Again, the expert team in this example is Expert Team X, the recommendations are based on the key metrics for the defined date range and the recommendations are based on optimizing a particular key metric 410. For example, depending on the key metric that the expert supervisor would like to optimize 410 (e.g., average volume 310, average time 320, average cost 330, etc.), the recommendations may be different. The recommendations may include recommendations related to checking with the team 420 to determine if there is any reason for negative metrics, e.g., why is claim processing time worse than the average team, why is the team processing less claims than the same time range from last year, etc. The recommendations may include recommendations related to coaching specific experts 430, e.g., identify expert that is disagreeing with automated claim analysis by a specific threshold, identify expert that is spending more time negotiating with body shops than other experts, etc. As described above, the expert module may include a series of rules that are used to judge the expert. As also described above, when a claim varies from the average based on one of the rules, the claim may be flagged. To continue with the example started above related to identifying an expert that is disagreeing with automated claim analysis by a specific threshold, the module may include a rule that all the claims where the expert was 20% higher in cost than the automated claim analysis should be flagged. The example key metrics shown in FIG. 3 may also show a flag rate for each of the key metrics, e.g., how many times was a team or individual expert flagged for deviating from the rule. The recommendations may include specific evidence based recommendations by the expert module including a link that shows each of the claims that were flagged, e.g., all the claims where the expert was 20% higher in cost than the automated claim analysis. The display of these claims may be ordered based on any type of factor, e.g., based on severity, based on the confidence level of the automated claim analysis, etc. The recommendations may also include an individual training plan 440 for the expert, e.g., how to address the flagged issues.

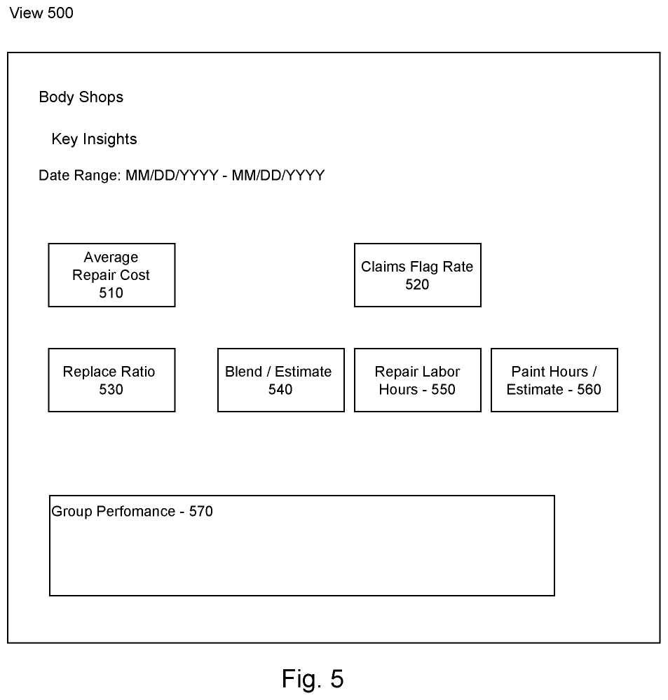

FIG. 5 shows a first view 500 of a third dashboard which provides a bodyshop behavior tool offering real-time bodyshop performance insights and network monitoring. The view 500 may be generated by a bodyshop module and include key insights (e.g., key metrics) into the performance of bodyshops. The individual who may be viewing the view 500 may be for example, a supervisor that is responsible for a series of bodyshops. The bodyshop module may include a model that analyzes all claims including those claims handled by the bodyshops for which the supervisor is responsible. The bodyshop module may generate the key metrics that are illustrated in view 300, e.g., an average repair cost 510, a claims flag rate 520, a replace ratio 530, a blend versus blend estimate ratio 540, a number of repair labor hours 550 and a paint hours versus estimate ratio 560. In addition, the view 500 may include a graphical view showing group performance 570 of the bodyshops, e.g., a graph that plots each of the selected bodyshops based on a flag rate and an average repair cost. As stated above, the key metrics described for this view 500 and for all the other views are only exemplary. Any key metrics that are generated by the AI may be used to display the performance of the bodyshops. In one example, each of the displayed key metrics may also be selected to show a graphical trend for the metric. In another example, the view 500 may include an exploded view of a vehicle and may provide the key metrics based on the different portions of the vehicle, e.g., hood, trunk, front left fender, front bumper, etc.

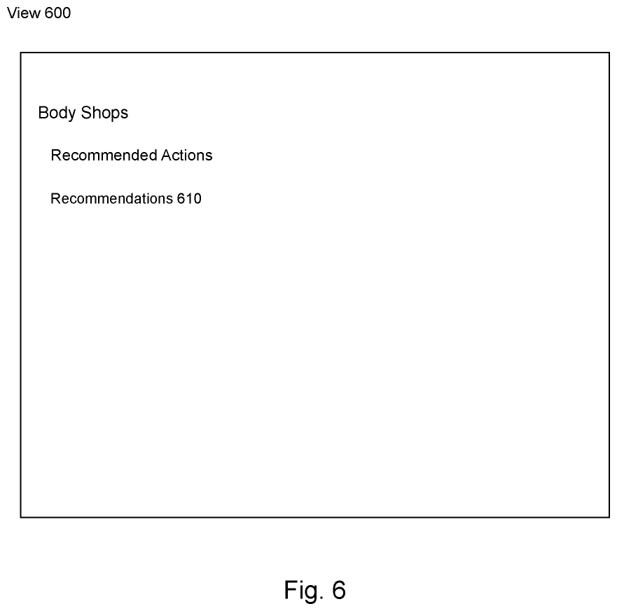

FIG. 6 shows a second view 600 of a third dashboard which provides a bodyshop behavior tool offering real-time bodyshop performance insights and network monitoring. The view 600 may also be generated by the bodyshop module that generated the view 500. As shown in FIG. 6, this second view 600 may show recommendations to improve the claims process with respect to one or more of the bodyshops. As described above, the recommendations may include specific evidence based recommendations 610 by the bodyshop module including a link that shows each of the claims that were flagged that correspond to the recommendation. Again, the claims may be flagged based on a set of rules implemented by the bodyshop module. The display of these claims may be ordered based on any type of factor, e.g., based on severity, based on the confidence level of the automated claim analysis, etc. To provide a specific example, the recommendation may be to speak to a particular bodyshop concerning their paint standards. The recommendation may include a link to the claims that were flagged for paint issues to provide the bodyshop with specific examples of the issues that have been identified for the bodyshop.

While the above example of the views 500 and 600 were described with reference to a supervisor of the insurance company, in another example, the bodyshop module may provide a dashboard for network managers, e.g., a manager of bodyshop. Detailed repair shop metrics can be generated and displayed. Repair shop performance metrics can include remove and replace (RR) metrics, repair labor hours, refinish times or labor hours, paint times, blend amounts and times, green/salvaged/refurbished/recycled part usage (in absolute terms and as a percentage of total part usage), usage of original equipment manufacturer (OEM) parts (in absolute terms and as a percentage of total part usage), usage of non-OEM new parts (in absolute terms and as a percentage of total part usage), historical leakage behaviors (based on historical adjustments to estimates or on an AI analysis of previous estimates and images), key to key time (K2K) (the time from an accident to the time the car is returned to its owner repaired), and adherence to and/or compliance with insurer guidelines. The repair shop can be compared to network peers. Alerts for performance issues can be generated and recommendations to address the issues, e.g., for bad repair standards. Thus, in this example, the bodyshop may self-correct issues prior to the insurance company speaking to the bodyshop.

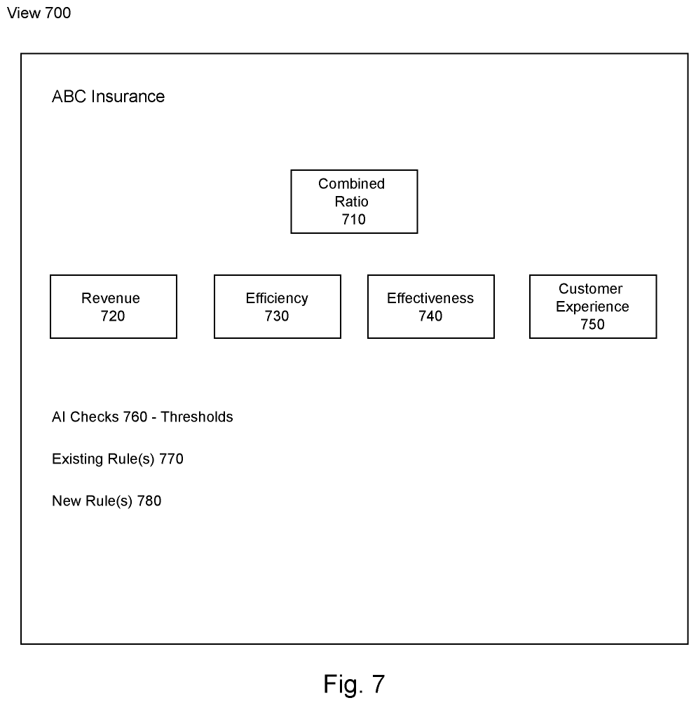

FIG. 7 shows a view 700 of a fourth dashboard which provides a back-end triage tool identifying the low-saving claims that do not require expert intervention. The view 700 may be generated by a simulation module and may include an automation dashboard. As shown in FIG. 7, the view 700 includes the key metrics that were described above with reference to FIG. 1, e.g., combined ratio 710, revenue 720, efficiency 730, effectiveness 740 and customer experience 750. However, in this view 700, these key metrics may be shown as a comparison between the actual key metric and if a particular rule were to be implemented. In this example, it will be considered that the rule that may be implemented/changed may be related to automatic review or approval for a particular repair shop. However, it should be understood that there are many rules that may be implemented by the exemplary embodiments. The rules are not limited to bodyshops but may relate to any of the subprocesses of the claims process. For example, the simulation module may evaluate the impact of a new automation threshold on key metrics. As shown in view 700, there may be various AI checks 760 that are performed for bodyshops, e.g., repair/replace, labor hours, paint, blend, etc. Each of these checks may be performed for a line item of the claim, e.g., bumper of the vehicle. The check may include an automation threshold, e.g., if the bodyshop estimate is within the automation threshold, no human interaction is required. The simulation module allows a user to change the thresholds and execute a simulation. The simulation will determine the key metrics associated with the claims that have already been processed and determine how changing these thresholds would have affected the key metrics, e.g., are all metrics improved, are some improved and some decreased, are some improved and some not changed significantly, etc. Based on these simulations, the user may determine whether the actually change the thresholds for performing AI checks on new claims moving forward. Similarly, the simulation module also includes a rules engine configuration engine to add/remove/change rules. The view 700 may show existing rules 770 and may also include a rules generator that includes an interactive way of adding/removing/changing rules such as the new rules 780. To provide an example of a rule related to a bodyshop, a new rule may be generated that relates to aiming of a headlight. The rule may state that if a line item of the claim includes the term “aim” various operators may be applied to the line item for the AI checks, e.g., does the line item exceed a certain number of labor hours, the number of labor hours may be related to a region, etc. Similar to the threshold discussion above, a user may run a simulation using the simulation engine to determine how implementing the added/removed/changed rule will affect the key metrics to make the decision regarding whether to actually implement the rule moving forward.

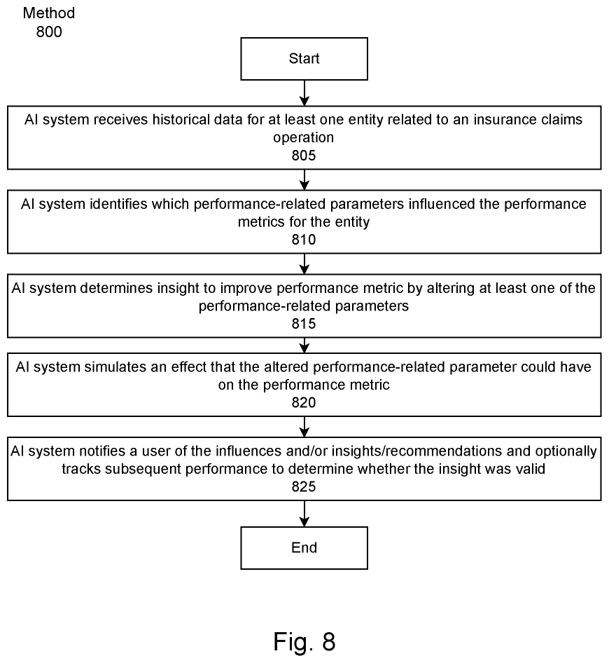

FIG. 8 shows a method 800 for an AI-based performance assessment according to various exemplary embodiments described herein.

In 805, the AI system receives historical data for at least one entity related to an insurance claims process, such as an employee, a repair shop, an automated claims processing system, etc. As described in detail above, the historical data can include performance-related parameters and associated performance metrics for the entity. The historical data is parameterized for input into one or more AI models.

In 810, the AI system identifies which performance-related parameters influenced the performance metrics for the entity. As described above, many different types of AI models (statistical or otherwise) can be used to extract the parameters that drive the performance. The AI model(s) for identifying influences can be continuously refined as new historical data is received.

In 815, the AI system determines an insight or a recommendation to improve the performance metric by altering at least one of the performance-related parameters. As described above, the insight can be based on any number of related parameters and/or parameters external to the insurance claims operation. The AI model(s) for determining insights can be continuously refined as new historical data and/or performance tracking data is received.

In 820, the AI system simulates an effect that the altered performance-related parameter could have on the performance metric. The simulation engine can be continuously refined as the actual results of recommendations are determined.

In 825, the AI system notifies a user of the influences and/or insights/recommendations. Optionally, the AI system can track subsequent performance of the one or more entities to determine whether the insight was valid.

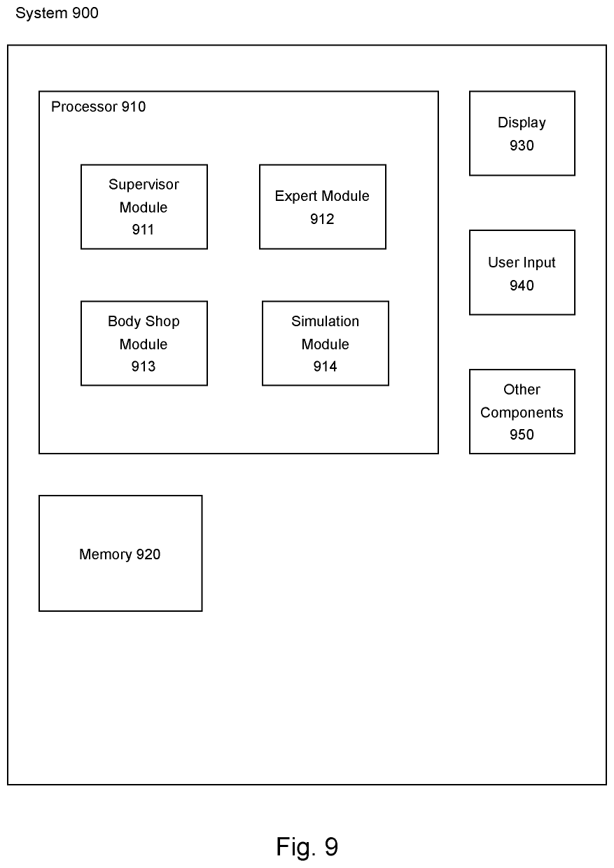

FIG. 9 shows an exemplary system 900 for implanting the AI system described herein. The system 900 comprises a processor 910, memory 920, a display 930, a user input device 940 and other components 950. The memory 920 may store any of the various data (e.g., claims data) described extensively throughout this description. It should be understood that the memory 920 may refer to a local storage medium such as an HDD or SSD on a local computer serving as the storage medium for system 900, but may also be understood to be an off-site storage medium such as cloud storage, or a distributed local network storage accessible by a computer.

The processor 910 may include a supervisor module 911, an expert module 912, a bodyshop module 913 and a simulation module 914. Each of these modules were described above. As described above, it should also be understood that the claims process may be separated into various constituent parts and each constituent part (or subparts) may have a module of the AI system dedicated to that part of the claims process. Furthermore, there is no requirement that a module be limited to a specific constituent part of the claims process, e.g., one module may be used for multiple parts of the claims process. Those skilled in the art will understand that the modules 911-914 may be implemented by the processor 910 as, for example, lines of code that are executed by the processor 910, as firmware executed by the processor 910, as a function of the processor 910 being an application specific integrated circuit (ASIC), etc.

The display 930 may be used, for example, to display the views 100-700 or any other information described herein. The user input 940 may be any component allowing a user to input information into the AI system. In some exemplary embodiments, the display 930 and user input 940 may be the same component, e.g., a touchscreen. The other components 950 may include any other component used by the system 900 to implement the AI system, e.g., battery, power supply, network interface card, etc.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described methods may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

We claim:

1. A method, comprising:
receiving first historical data for an entity related to an insurance claims operation, the first historical data including performance-related parameters and at least one associated performance metric for claims processed by the entity during a first duration of time, wherein the first historical data is parameterized for input into one or more artificial intelligence (AI) models;
identifying, from the AI model fit to the first historical data, one or more of the performance-related parameters that influenced the at least one associated performance metric;
determining, from one or more performance-related parameters, a recommendation to improve the at least one associated performance metric; and
providing a notification of the recommendation.

2. The method of claim 1, wherein the notification of the recommendation comprises a link to one or more of the claims processed by the entity and related to the recommendation.

3. The method of claim 2, wherein the one or more claims are ordered based on a factor related to the recommendation.

4. The method of claim 3, wherein the factor comprises one of a severity of the one or more performance-related parameters in each of the one or more claims or a confidence level of the AI model in the one or more of the performance-related parameters that influenced the at least one associated performance metric in each of the one or more claims.

5. The method of claim 1, further comprising:
receiving second historical data for the entity captured for a second duration of time that is after the first duration of time and after the notification was provided;
identifying, from the AI model, the at least one associated performance metric based on the first historical data and the second historical data; and
determining whether the recommendation influenced a change in the at least one associated performance metric between the first duration of time and the second duration of time.

6. The method of claim 1, further comprising:
altering a rule related to at least one of the performance-related parameters, wherein the altering comprises one of changing a threshold of the at least one of the performance-related parameter, adding a new rule, modifying the rule or deleting the rule.

7. The method of claim 6, further comprising:
simulating, based on the AI model, an effect that the altered rule has on the at least one associated performance metric over a simulated duration of time.

8. The method of claim 7, further comprising:
refining, by the AI model, the altered rule based on a determination of whether the altered rule changed the at least one associated performance metric over an actual duration of time.

9. The method of claim 1, wherein the entity is one of an expert or a team of experts involved in the insurance claims operation and the at least one associated performance metric comprises one of an average volume of claims processed during a predetermined period of time, an average amount of time spent for each of the claims or an average cost of the claims processed.

10. The method of claim 9, wherein the recommendation comprises an individual training plan for the expert or a team of experts.

11. The method of claim 1, wherein the entity is a bodyshop involved in the insurance claims operation and the at least one associated performance metric comprises one of an average cost of repairs for the claims, a replace ratio for the claims, a number of blends versus a number of blends estimated for each claim, a number of labor hours for each claim, or a number of paint hours versus a number of paint hours estimated for each claim.

12. The method of claim 10, further comprising:
comparing one or more line items of a claim performed by the bodyshop to a rule; and
flagging each line item that violates the rule, wherein the at least one associated performance metric comprises a number of flagged line items for each claim.

13. The method of claim 1, wherein respective historical data is received for a plurality of entities related to the insurance claims operation and the AI model determines correlations between the entities.

14. The method of claim 1, wherein the at least one associated performance metric comprises one of a combined ratio comparing paid claims and expenses to earned premiums, an earned revenue comprising an earned premium per claim, an efficiency comprising expert expenses per claim, an effectiveness comprising a payout per claim or a customer experience comprising an amount of time a customer was without a vehicle involved in the claim.

15. A system, comprising:
a memory configured to store first historical data for an entity related to an insurance claims operation, the first historical data including performance-related parameters and at least one associated performance metric for claims processed by the entity during a first duration of time, wherein the first historical data is parameterized for input into one or more artificial intelligence (AI) models; and
one or more processors configured to:
identify, from the AI model fit to the first historical data, one or more of the performance-related parameters that influenced the at least one associated performance metric;
determine, from one or more performance-related parameters, a recommendation to improve the at least one associated performance metric; and
provide a notification of the recommendation.

16. The system of claim 15, wherein the notification of the recommendation comprises a link to one or more of the claims processed by the entity and related to the recommendation.

17. The system of claim 16, wherein the one or more claims are ordered based on a factor related to the recommendation, wherein the factor comprises one of a severity of the one or more performance-related parameters in each of the one or more claims or a confidence level of the AI model in the one or more of the performance-related parameters that influenced the at least one associated performance metric in each of the one or more claims.

18. The system of claim 15, wherein the one or more processors are further configured to:
receive second historical data for the entity captured for a second duration of time that is after the first duration of time and after the notification was provided;
identify, from the AI model, the at least one associated performance metric based on the first historical data and the second historical data; and
determine whether the recommendation influenced a change in the at least one associated performance metric between the first duration of time and the second duration of time.

19. The system of claim 15, wherein the one or more processors are further configured to:
alter a rule related to at least one of the performance-related parameters, wherein altering the rule comprises one of changing a threshold of the at least one of the performance-related parameter, adding a new rule, modifying the rule or deleting the rule;
simulate, based on the AI model, an effect that the altered rule has on the at least one associated at least one associated performance metric over a simulated duration of time; and
refine, by the AI model, the altered rule based on a determination of whether the altered rule changed the at least one associated performance metric over an actual duration of time.

20. The system of claim 15, wherein the entity is a bodyshop involved in the insurance claims operation and the at least one associated performance metric comprises one of an average cost of repairs for the claims, a replace ratio for the claims, a number of blends versus a number of blends estimated for each claim, a number of labor hours for each claim, or a number of paint hours versus a number of paint hours estimated for each claim, wherein the one or more processors are further configured to:
compare one or more line items of a claim performed by the bodyshop to a rule; and
flag each line item that violates the rule, wherein the at least one associated performance metric comprises a number of flagged line items for each claim.
